(19) United States
(12) Patent Application Publication
(10) Pub. No.: US 2016/0034528 A1
(43) Pub. Date: Feb. 4, 2016

(54) CO-PROCESSOR-BASED ARRAY-ORIENTED DATABASE PROCESSING

(71) Applicants: Indrajit ROY, Palo Alto, CA (US); Feng LIU, Princeton, NJ (US); Vanish TALWAR, Palo Alto, CA (US); Shimin CHEN, Haidian, Beijing (CN); Jichuan CHANG, Palo Alto, CA (US); Parthasarathy RANGANATHAN, Palo Alto, CA (US); HEWLETT-PACKARD DEVELOPMENT COMPANY, L.P., Houston, TX (US)

(72) Inventors: Indrajit Roy, Palo Alto, CA (US); Feng Liu, Palo Alto, CA (US); Vanish Talwar, Palo Alto, CA (US); Shimin Chen, Beijing (CN); Jichuan Chang, Palo Alto, CA (US); Parthasarathy Ranganathan, Palo Alto, CA (US)

(21) Appl. No.: 14/775,329

(22) PCT Filed: Mar. 15, 2013
(86) PCT No.: PCT/CN2013/072674

§ 371 Date: Sep. 11, 2015

(51) Int. Cl. G06F 17/30

(52) U.S. Cl. CPC G06F 17/30424; G06F 17/30289; G06F 17/30486

(57) ABSTRACT

A technique includes receiving a user input in an array-oriented database. The user input indicates a database operation and processing a plurality of chunks of data stored by the database to perform the operation. The processing in dudes selectively distributing the processing of the plurality of chunks between a first group of at least one central processing unit and a second group of at least one co-processor.

### BACKGROUND

Array processing has wide application in many areas including machine learning, graph analysis and image processing. The importance of such arrays has led to new storage and analysis systems, such as array-oriented databases (AODBs). An AODB is organized based on a multi-dimensional array data model and supports structured query language (SQL)-type queries with mathematical operators to be performed on arrays, such as operations to join arrays, operations to filter an array, and so forth. AODBs have been applied to a wide range of applications, including seismic analysis, genome sequencing, algorithmic trading and insurance coverage analysis.

### BRIEF DESCRIPTION OF THE DRAWINGS

FIG. 1 is a schematic diagram of an array-oriented database (AODB) system according to an example implementation.

FIG. 2 is an illustration of a processing work flow used by the AODB system of FIG. 1 according to an example implementation.

FIG. 3 is an illustration of times for a central processing unit (CPU) and a co-processor to process chunks of data as a function of chunk size.

FIGS. 4 and 5 illustrate an example format conversion performed by the AODB system of FIG. 2 to condition data for processing by a co-processor according to an example implementation.

FIG. 6 is an illustration of the performances of co-processor-based processing and CPU-based processing versus work load type according to an example implementation.

FIGS. 7 and 8 are flow diagrams depicting techniques to process a user input to an AODB system by selectively using CPU-based processing and co-processor-based processing according to example implementations.

### DETAILED DESCRIPTION

An array-oriented database (AODB) may be relatively more efficient than a traditional database for complex multi-dimensional analyses, such as analyses that involve dense matrix multiplication, K-means clustering, sparse matrix computation and image processing, just to name a few. The AODB may, however, become overwhelmed by the complexity of the algorithms and the dataset size. Systems and techniques are disclosed herein for purposes of efficiently processing queries to an AODB-based system by distributing the processing of the queries among central processing units (CPUs) and co-processors.

A co-processor, in general, is supervised by a CPU, as the co-processor may be limited in its ability to perform some CPU-like functions (such as retrieving instructions from system memory, for example). However, the inclusion of one or multiple co-processors in the processing of queries to an AODB-based system takes advantage of the co-processor's ability to perform array-based computations. In this manner, a co-processor may have a relatively large number of processing cores, as compared to a CPU. For example, a co-processor such as the NVIDIA Tesla M2090 graphics processing unit (GPU) may have 16 multi-processors, with each having 32 processing cores for a total of 512 processing cores. This is in comparison to a given CPU, which may have, for example, 8 or 16 processing cores. Although a given CPU processing core may possess significantly more processing power than a given co-processor processing core, the relatively large number of processing cores of the co-processor combined with the ability of the co-processor's processing cores to process data in parallel make the co-processor quite suitable for array computations, which often involve performing the same operations on a large number of array entries.

For example implementations disclosed herein, the co-processor is a graphics processing unit (GPU), although other types of co-processors (digital signal processing (DSP) co-processers, floating-point arithmetic co-processors, and so forth) may be used, in accordance with further implementations.

In accordance with example implementations, the GPU(s)and CPU(s) of an AODB system maybe disposed on at least one computer (a server, a client, an ultrabook computer, a desktop computer, and so forth). More specifically, the GPU may be disposed on an expansion card of the computer and may communicate with components of the computer over an expansion bus, such as a Peripheral Component Interconnect Express (PCIe) bus, for example. The expansion card may contain a local memory, which is separate from the main system memory of the computer; and a CPU of the computer may use the PCIe bus for purposes of transferring data and instructions to the GPU's local memory so that the GPU may access the instructions and data for processing. Moreover, when the GPU produces data as a result of this processing, the data is stored in the GPU'S local memory; and a CPU may likewise use PCIe bus communications to instruct the transfer of data from the GPU's local memory to the system memory.

The GPU may be located on a bus other than a PCIe bus in further implementations. Moreover, in farther implementations, the GPU may be a chip or chip set that is integrated into the computer, and as such, the GPU may not be disposed on an expansion card.

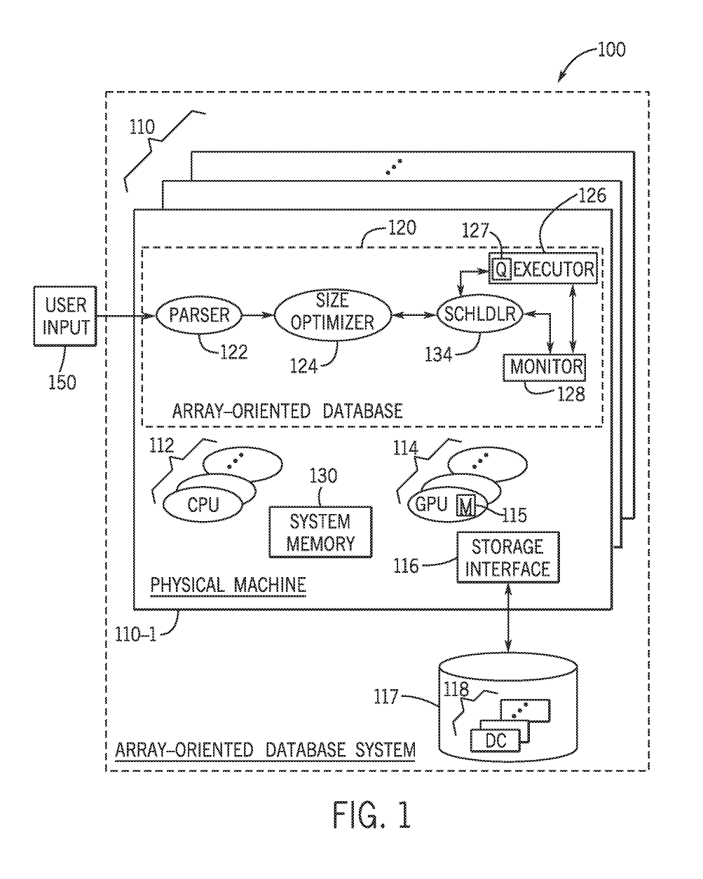

FIG. 1 depicts an example implementation of an AODB-based database system 100 according to an example implementation. The system 100 is constructed to process a user input 150 that describes an array-based operation. As an example, in accordance with example implementations, the system 100 may be constructed to process SciDB-type queries, where “SciDB” refers to a specific open source array management and analytics database, in this manner, the user input 150 may be, in accordance with some example implementations, an array query language (AQL) query (similar to a SQL query but specifying mathematical operations) or an array functional language (AFL) query. Moreover, the user input 150 maybe generated, for example, by an array-based programming language, such as R.

In general, the user input 150 may be a query or a user defined function. Regardless of its particular form, the user input 150 defines an operation to be performed by the database system 100. In this manner, a query, in general, may use operators that are part of the set of operators defined by the AODB, where as the user-defined function allows the user to specify custom algorithms and/or operations on array data.

A given user input 150 may be associated with one or multiple units of data called “data chunks” herein. As an example, a given array operation that is described by a user input 150 may be associated with partitions of one or multiple arrays, and each chunk corresponds to one of the partitions. The system 100 distributes the compute tasks for the data chunks among one or multiple CPUs 112 and one or multiple GPUs 114 of the system 100. In this context, a “compute task” maybe viewed as the compute kernel for a given data chunk. Each CPU 112 may have one or multiple processing cores (8 or 16 processing cores, as an example); and each CPU processing core is a potential candidate for executing a thread to perform a given compute task. Each GPU 114 may also contain one or multiple processing cores (512 processing cores, as an example); and the processing cores of the GPU 114 may perform a given compute task assigned to the GPU 114 in parallel.

For the foregoing example, it is assumed that the AODB system 100 is formed from one or multiple physical machines 110, such as example physical machine 110-1. In general, the physical machines 110 are actual machines that are made up of actual hardware and actual machine executable instructions, or “software.” In this regard, as depicted in FIG. 1, the physical machine 110-1 includes such hardware as one or multiple CPUs 112; one or multiple GPUs 114; a main system memory 130 (i.e., the working memory for the machine 110-1); a storage interface 116 that communicates with storage 117 (one or multiple hard disk drives, solid state drives, optical drives, and so forth); a network interface, and so forth, as can be appreciated by the skilled artisan.

As depicted in FIG. 1, each GPU 114 has a local memory 115 which receives (via PCIe bus transfers, for example) instructions and data chunks to be processed by the GPU 114 torn the system memory 130 and stores data chunks resulting from the GPU's processing, which are transferred back (via PCIe bus transfers, for example) into the system memory 130. Moreover, one or more of the CPUs 112 may execute machine executable instructions to form modules, or components, of an AODB-based database 120 for purposes of processing the user input 150.

For the example implementation depicted in FIG. 1, the AODB database 120 includes a parser 122 that parses the user input 150; and as a result of this parsing, the parser 122 identifies one or multiple data chunks to be processed and one or compute tasks to perform on the data chunk(s). The AODB database 120 further includes a scheduler 134 that schedules the compute tasks to be performed by the CPU(s) 112 and GPU(s) 114. In this manner, the scheduler 134 places data indicative of the compute tasks in a queue 127 of an executor 126 and tags this data to indicate which compute tasks are to be performed by the CPU(s) 112 and which compute tasks are to be performed by the GPU(s) 114.

Based on the schedule indicated by the data in the queue 127, the executor 126 retrieves corresponding data chunks 118 from the storage 117 and stores the chunks 118 in the system memory 130. For a CPU-executed compute task, the executor 126 initiates execution of the compute task by the CPU(s) 112; and the CPU(s) 112 access the data chunks from the system memory 130 for purposes of performing the associated compute tasks. For a GPU-executed task, the executor 126 may transfer the appropriate data chunks from the system memory 130 into the GPU's local memory 115 (via a PCIe bus transfer, for example).

The AODB database 120 further includes a size regulator, or size optimizer 124, that regulates the data chunk sizes for compute task processing. In this manner, although the data chunks 118 may be sized for efficient transfer of the chunks 118 from the storage 117 (and for efficient transfer of processed data chunks to the storage 117), the size of the data chunk 118 may not be optimal for processing by a CPU 112 or a GPU 114. Moreover, the optimal size of the data chunk for CPU processing may be different than the optimal size of the data chunk for GPU processing.

In accordance with some implementations, the AODB database 120 recognizes that the chunk size influences the performance of the compute task processing. In this manner, for efficient GPU processing, relatively large chunks may be beneficial due to (as examples) the reduction in data transfer overhead, as relatively larger chunks are more efficiently transferred into and out of the GPU's local memory 115 (via PCIe bus transfers, for example); and relatively larger chunks enhances GPU processing efficiency, as the GPU's processing cores having a relatively large amount of data to process in parallel. This is to be contrasted to the chunk size for CPU processing, as a smaller chunk size may enhance allocating data locality and reduce the overhead of accessing data to be processed among CPU 112 threads.

The size optimizer 124 regulates the data chunk size based on the processing entity that performs the related compute task on that chunk. For example, the size optimizer 124 may load relatively large data chunks 118 from the storage 117 and store relatively large data chunks in the storage 117 for purposes of expediting communication of this data to and from the storage 117. The size optimizer 124 selectively merges and partitions the data chunks 118 to produce modified size data chunks based on the processing entity that processes these chunks. In this manner, in accordance with an example implementation, the size optimizer 124 partitions the data chunks 118 into multiple smaller data chunks when these chunks correspond to compute tasks that are performed by a CPU 112 and stores these partitioned blocks along with the corresponding CPU tags in the queue 127. To the contrary, the size optimizer 124 may merge two or multiple data chunks 118 together to produce a relatively larger data chunk for GPU-based processing; and the size optimizer 124 may store this merged chunk in the queue 127 along with the appropriate GPU tag.

FIG. 3 is an illustration 300 of the relative CPU and GPU response times versus chunk size according to an example implementation. In this regard, the bars 302 of FIG. 3 illustrate the CPU response times for different chunk sizes; and the bars 304 represent the corresponding GPU response times for the same chunk sizes. As can be seen by trends 320 and 330 for CPU and GPU processing, respectively, in general, the trend 330 for the GPU processing indicates that the response times for the GPU processing decrease with chunk size, whereas the trend 320 for CPU processing depicts the response times for the CPU processing increase with chunk size.

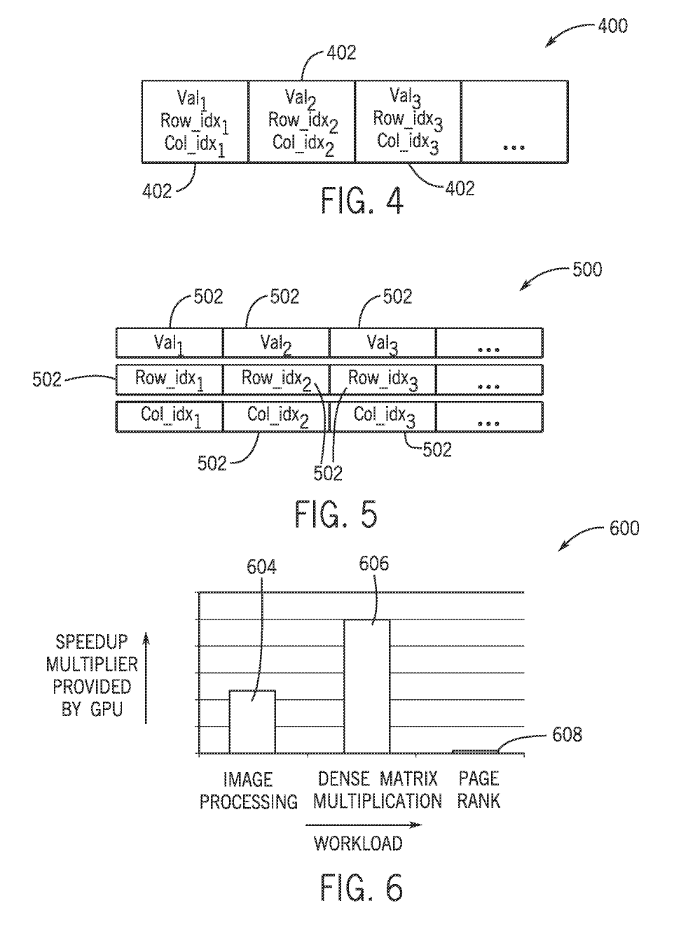

In accordance with example implementations, the executor 126 may further decode, or convert, the data chunk into a format that is suitable for the processing entity that performs the related compute task. For example, the data chunks 118 maybe stored in the storage 117 in a triplet format. An example triplet format 400 is depicted in FIG. 4. In the example triplet format 400, the data is arranged as an array of structures 402, which may not be a suitable format by processing by a GPU 114 but may be a suitable format by processing by a CPU 112. Therefore, if a given data chunk is to be processed by a CPU 112, the executor 126 may not perform any further format conversion. However, if the data chunk is to be processed by a GPU 114, in accordance with example implementations, the executor 126 may convert the data format into one that is suitable for the GPU 114. Using the example of FIG. 4, the executor 128 may convert the triplet form at 400 of FIG. 4 into a structure 500 of arrays 502 (depicted in FIG. 5), which is suitable for parallel processing by the processing cores of the GPU 114.

Referring back to FIG. 1, in accordance with example implementations, the scheduler 134 may assign compute tasks to the CPU(s)112 and GPU(s) 114 based on static criteria. For example, the scheduler 134 may assign a fixed percentage of compute tasks to the GPU(s) 114 and assign the remaining compute tasks to the CPU(s) 112.

In accordance with further implementations, the scheduler 134 may employ a dynamic assignment policy based on metrics that are provided by a monitor 128 of the AODB database 120. In this manner, the monitor 128 may monitor such metrics as CPU utilization, CPU compute task processing time, GPU utilization, GPU compute task processing time, the number of concurrent GPU tasks and so forth; and based on these monitored metrics, the scheduler 134 dynamically assigns the compute tasks, which provides the scheduler 134 the flexibility to tune performance at runtime. In accordance with example implementations, the scheduler 134 may make the assignment decisions based on the metrics provided by the monitor 128 and static policies. For example, the scheduler 134 may assign a certain percentage of compute tasks to the GPU(s) 114 until a fixed limit on the number of concurrent GPU tasks are reached or until the GPU compute task processing time decreases below a certain threshold. Thus, in accordance with some implementations, the scheduler 134 may exhibit a bias toward assigning compute tasks to the GPU(s) 114. This bias, in turn, takes advantage of a potentially faster compute task processing time by the GPU 114.

In this manner, FIG. 6 depicts an illustration of an observed relative speedup multiplier associated with using GPU-based compute task processing versus CPU-based compute task processing for different operations. These are shown by speedup multipliers 604, 606 and 608 for image processing, dense matrix multiplication and page rank calculations, respectively. As can be seen from FIG. 6, the GPU provides different speedup multipliers depending on the data type, and for the example of FIG. 6, the maximum speed multiplier occurs for dense matrix multiplication.

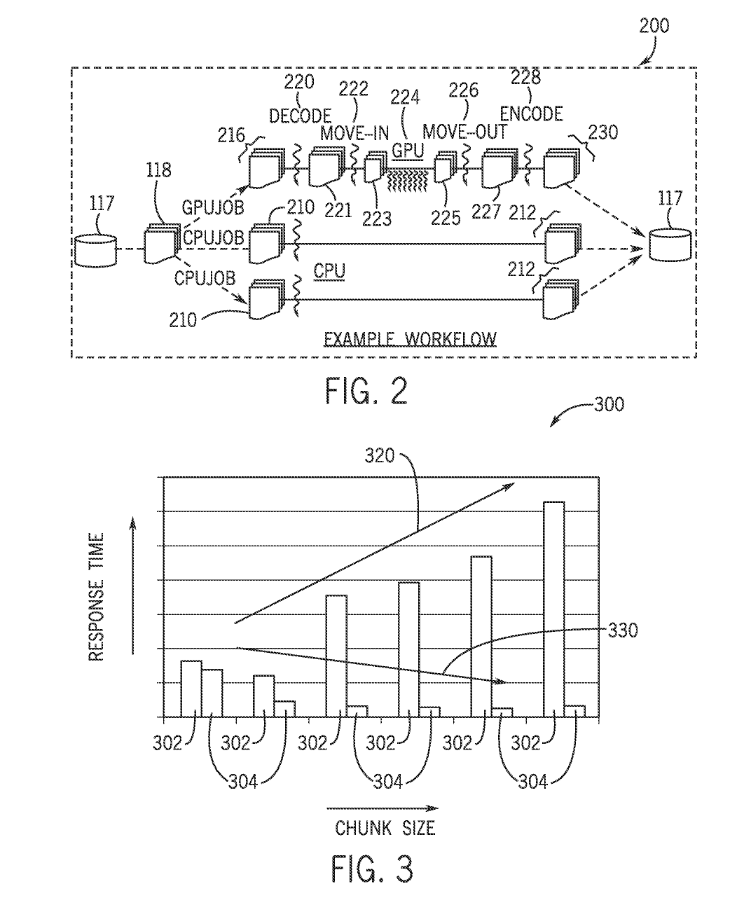

Referring to FIG. 2, to summarize, in accordance with an example implementation, the AODB database 120 establishes a work flow 200 for distributing compute tasks among the CPU(s) 112 and GPU(s) 114. The workflow 200 includes retrieving data chunks 118 from the storage 117 and selectively assigning corresponding compute tasks between the CPU(s) 112 and GPU(s) 114, which results in GPU and CPU tasks, or jobs. The workflow 200 includes selectively merging and partitioning the data chunks 118 as disclosed herein to form partitioned chunks 210 for the illustrated CPU jobs of FIG. 2 and merged chunks 218 for the illustrated GPU job of FIG. 2.

The CPU(s) 112 process the data chunks 210 to form corresponding chunks 212 that are communicated back to the storage 117. The data chunks 218 for the GPU job may be further decoded, or reformatted (as indicated by reference numeral 220), to produce corresponding reformatted data chunks 221 that are moved in (as illustrated by reference numeral 222) into the GPU's memory 115 (via a PCIe bus transfer, for example) to form local blocks 223 to be processed by the GPU (s) 114. After GPU processing 224 that produces data blocks 225, the work flow 200 includes moving out the blocks 225 from the GPU local memory 115 (as indicated at reference numeral 226), such as by a PCIe bus transfer, which produces blocks 227 and encoding (as Indicated by reference numeral 228) the blocks 227 (using the CPU, for example) to produce reformatted blocks 230 that are then transferred to the storage 117.

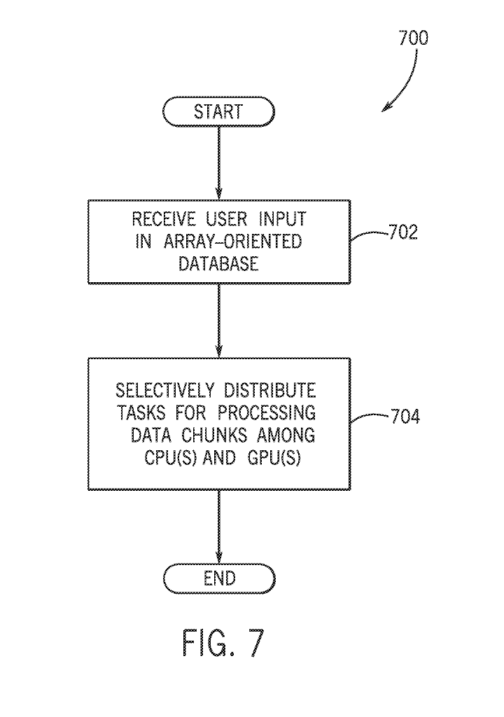

Thus, referring to FIG. 7, to generalize, in accordance with an example implementation, a technique 700 generally includes receiving (block 702) a user input in an array-oriented database. Pursuant to the technique 700, tasks for processing the chunks are selectively assigned (block 704) among one or more CPUs and one or more GPUs.

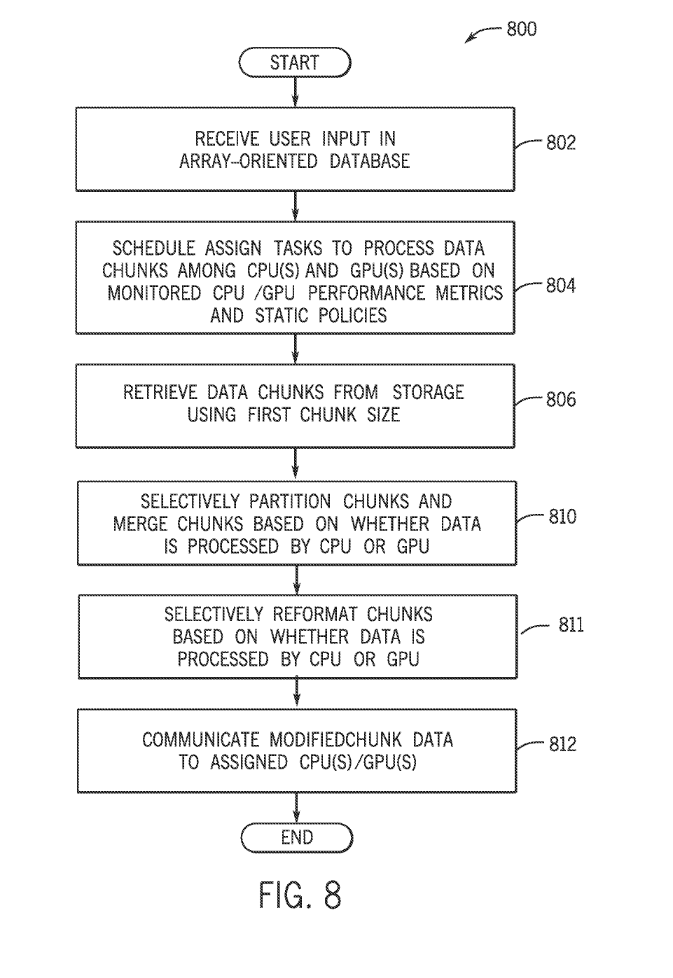

More specifically, FIG. 8 depicts a technique 800 that may be performed in accordance with example implementations. Pursuant to the technique 800, a user input is received, pursuant to block 802 and tasks for processing of data chunks associated with the user input are assigned (block 804) based on at least one monitored CPU and/or GPU performance metric. The data chunks may be retrieved from storage using a first chunk size optimized for the retrieval, pursuant to block 806; and then the chunks may be selectively partitioned/merged based on the processing entity that processes the chunks, pursuant to block 810. The technique 800 also includes communicating (block 812) the partitioned/merged chunks to the CPU(s) and GPU(s) according to the assignments.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
receiving a user input in an array-oriented database, the user input indicating a database operation; and
processing a plurality of chunks of data stored by the database to perform the database operation, the processing comprising selectively distributing the processing of the plurality of chunks between a first group of at least one central processing unit and a second group of at least one co-processor.

2. The method of claim 1, further comprising selectively partitioning at least one chunk of a subset of the chunks based at least in part on whether the subset is being processed by the first group of at least central processing unit or by the second group of at least one co-processor.

3. The method of claim 2, wherein selectively partitioning the at least one chunk of the subset comprises partitioning the at least one chunk if the subset is allocated to a central processing unit of the first group.

4. The method of claim 1, further comprising selectively merging at least two chunks of a subset of the chunks based at least in part on whether the subset is being processed by the first group of at least central processing unit or by the second group of at least one co-processor.

5. The method of claim 4, wherein selectively merging the at least two chunks of the subset comprises merging the at least two chunks if the subset is allocated to a co-processor of the second group.

6. The method of claim 1, further comprising formatting at least one chunk of a subset of the chunks based at least in part on whether the subset is being processed by the first group of at least central processing unit or by the second group of at least one co-processor.

7. The method of claim 1, wherein selectively distributing the processing comprises selectively distributing the processing based at least in part on a utilization of the at least one co-processor and a utilization of the at least one central processing unit.

8. An apparatus comprising:
an array-oriented database;
a first group of at least one central processing unit;
a second group of at least one co-processor; and
a scheduler to, in response to a user input that indicates a database operation, selectively distribute processing of a plurality of chunks stored in the database between the first group and the second group.

9. The apparatus of claim 8, further comprising a data size regulator to selectively partition at least one chunk of a subset of the chunks based at least in part on whether the scheduler allocates the subset to be processed by the first group of at least central processing unit or by the second group of at least one co-processor.

10. The apparatus of claim 9, wherein the data size regulator is adapted to selectively partition the at least one chunk of the subset based on whether the subset is allocated to a central processing unit of the first group.

11. The apparatus of claim 9, wherein the data size regulator is adapted to selectively merge at least two chunks of a subset of the chunks based at least in part on whether the subset is being processed by the first group of at least central processing unit or by the second group of at least one co-processer.

12. The apparatus of claim 8, further comprising a data size regulator to load the plurality of chunks in response to the user input and selectively increase and decrease a chunk size associated with the chunks for a subset of the chunks based at least in part on whether the subset is being processed by the first group of at least central processing unit or by the second group of at least one co-processor.

13. The apparatus of claim 8, further comprising:
a monitor to determine a utilization of the at least one co-processor and a utilization of the at least one central processing unit.

14. The apparatus of claim 13, wherein the scheduler is adapted to selectively distribute the chunks based at least in part on the determination by the monitor.

15. The apparatus of claim 8, wherein the user input comprises a user-defined function or a database query.

16. An article comprising a non-transitory computer readable storage medium to store instructions that when executed by a computer cause the computer to:
receive a user input in an array-oriented database; and
in response to the user input, selectively distribute processing of a plurality of chunks stored in the database between a first group of at least one central processing unit and a second group of at least one co-processor.

17. The article of claim 16, the storage medium storing instructions that when executed by the computer cause the computer to selectively partition at least one chunk of a subset of the chunks based at least in part on whether the subset is being processed by the first group of at least central processing unit or by the second group of at least one co-processor.

18. The article of claim 18, the storage medium storing instructions that when executed by the computer cause the computer to selectively merge at least two chunks of a subset of the chunks based at least in part on whether the subset is being processed by the first group of at least central processing unit or by the second group of at least one co-processor.

19. The article of claim 16, the storage medium storing instructions that when executed by the computer cause the computer to form at at least one chunk of a subset of the chunks based at least in part on whether the subset is being processed by the first group of at least central processing unit or by the second group of at least one co-processor.

20. The article of claim 16, the storage medium storing instructions that when executed by the computer cause the computer to selectively distribute the processing based at least in part on a utilization of the at least one co-processor and a utilizations of the at least one central processing unit.
